(19) United States
(12) Patent Application Publication
(10) Pub. No.: US 2021/0059262 A1
(43) Pub. Date: Mar. 4, 2021

(54) MIXTURE OF FUNGAL BIOCONTROLLERS FOR CONTROLLING FUNGI THAT CAUSE DEAD ARM OF GRAPEVINE

(71) Applicant: UNIVERSIDAD DE CHILE, Santiago (CL)

(72) Inventors: Jaime Rolando MONTEALEGRE ANDRADE, La Pintana Santiago (CL); Luz Maria Sara PEREZ ROEPKE, Providencia Santiago (CL)

(21) Appl. No.: 16/958,537

(22) PCT Filed: Dec. 27, 2018
(86) PCT No.: PCT/IB2018/060658

§ 371 Date: Jun. 26, 2020

(30) Foreign Application Priority Data
Dec. 29, 2017 (CL) 3480-2017

(51) Int. Cl. A01N 63/38

(52) U.S. Cl. CPC A01N 63/38

(57) ABSTRACT

A biocontrol composition for phytopathogenic fungi, having Trichoderma harzianum, Clonostachys rosea and an agronomically appropriate vehicle is disclosed. Also disclosed is a method for preventing and controlling fungal diseases in plants, by using the composition on a plant susceptible to developing a fungal infection.

### TECHNICAL FIELD

The present invention relates to the agriculture industry, especially the cultivation of plants and more especially in the cultivation of grapevines. In particular, the present invention relates to a product and method for the biocontrol of fungal diseases in plants mediated by fungi of the Botryosphaeriaceae family. Firstly, the invention focuses on a biocontrol composition comprising Trichoderma harzianum and Clonostachys rosea, and secondly, on a method for preventing and controlling fungal diseases in plants, especially mediated by fungi of the Botryosphaeriaceae family or other pathogens causing diseases of the grapevine wood. Wherein the method comprises applying the biocontrol composition containing a mixture of Trichoderma harzianum and Clonostachys rosea.

### SUMMARY

The invention relates to a biocontroller product for phytopathogenic fungi, specifically a mixture of biocontrollers comprising Trichoderma harzianum and Clonostachys rosea. Inventors have determined that this specific mixture has the ability to control fungi of the Botryosphaeriaceae family, such as Neofusicoccum australe and Diplodia seriata, causal agents of the dead arm disease of grapevine.

The product of the invention can be used to prevent and control these diseases of the grapevine wood in vineyards focused on the production of wine, pisco and table grapes. Additionally, the inventors have determined that the product of the invention is capable of eliciting defense mechanisms in grapevine plants.

In the state of the art, there are biocontroller products that employ only one fungus of the composition of the invention, but the mixture of Trichoderma harzianum and Clonostachys rosea of the present invention has not been assayed until now. The same inventors, in conferences, disclosed previous efforts testing only one of the components of the invention. For instance, Luz Maria Pérez and others submitted the paper in the XXIV CONGRESO SOCIEDAD CHILENA DE FITOPATOLOGÍA (2015), “Elicitación De Respuesta Defensiva En Plántulas De Vid Cvs. Cabernet Sauvignon y Chardonnay”, where a selection of biological antagonists for treatment for the dead arm disease of grapevine is described, specifying that fungi antagonistic to N. australe and D. seriata were selected. It is mentioned that one of the selected antagonists, Trizian 1 (Trichoderma harzianum), in addition to possessing the characteristic of controlling these phytopathogens, possesses the ability to elicit a defensive response in grapevine plants of cvs. Cabernet Sauvignon and Chardonnay by inducing the activity of certain enzymes.

However, the results obtained with only Trichoderma harzianum are not good enough for the control of phytopathogens, thereby the technical problem of finding a more efficient biocontroller in the prevention and control of these fungi remains.

On the other hand, in the same manner as studied for Trichoderma harzianum, the mixture of biocontroller fungi of the invention, maintains the ability to promote development and elicit the defense response, reflected in the induction of certain enzymes associated with such response, also presenting a better ability to biocontrol phytopathogenic fungi.

### Technical Problem and Solution

To remedy the problem posed, a composition is presented, comprising a mixture of Trichoderma harzianum and Clonostachys rosea, and a method, comprising applying this composition, which allows preventing and controlling fungal diseases in plants, especially those caused by fungi of the Botryosphaeriaceae family.

### DETAILED DESCRIPTION OF THE INVENTION

The present invention consists of a mixture of fungal biocontrollers, specifically Trichoderma harzianum and Clonostachys rosea, that have the ability to control phytopathogenic fungi, especially of the Botryosphaeriaceae family, such as Neofusicoccum australe (Botryosphaeria australis) and Diplodia seriata (Botryosphaeria obtusa), causal agents of the “dead arm of the grapevine” disease. The mixture includes in a ratio between 1:5 and 5:1 (v/v) of conidia suspensions of the Trichoderma harzianum and Clonostachys rosea strains which use a total established concentration between 1×10⁶ to 1×10⁹ conidia per milliliter, especially 1×10⁸ conidia per milliliter. This mixture can be used to prevent and control diseases of the grapevine wood in vineyards focused on the production of wine, pisco and table grapes. Additionally, the mixture is capable of eliciting defense mechanisms in the grapevine plants of cvs. Cabernet Sauvignon and Chardonnay, through the induction of certain enzymes, such as phenylalanine ammonium lyase (PAL), endochitinases (ECH) and endoglucanases (EGL).

Thus, the invention relates to a biocontrol composition for phytopathogenic fungi comprising Trichoderma harzianum and Clonostachys rosea; which are present in a ratio of between 1:5 to 5:1. This mixture is formed with suspensions of conidia of Trichoderma harzianum and Clonostachys rosea.

The biocontrol composition of the invention additionally comprises an appropriate vehicle, which is selected from the group consisting of water, aqueous solutions, thick suspensions, granules and powders. Additionally, the composition of the invention comprises additives selected from the group consisting of fertilizer, insecticide, fungicide, nematicide and mixtures thereof.

In a second aspect, the invention focuses on a method to prevent and control fungal diseases in plants which comprises applying the biocontrol composition comprising a mixture of Trichoderma harzianum and Clonostachys rosea, in a plant prone to developing a fungal infection; wherein the plant disease is mediated by fungi of the Botryosphaeriaceae family, and especially by fungi of the species Neofusicoccum australe and Diplodia seriata; and wherein the plant is selected from the group consisting of flowers, ornamental plants, fruit vegetables, hydroponic crops, leafy vegetables and cabbage crops, pome fruits, deciduous trees, grapevines, citrus, pines, stone fruits, nuts, grains and herbs. Especially the plants to be treated are grapevines.

Applying of the composition of the invention is carried out by any method available in the art, such as: spraying, liquid or dry application in furrows, soaking of plant material in pots, direct incorporation into the soil or planting mixtures in the greenhouse, granular formulations or granules, or direct treatment of seeds. Wherein the composition of the invention is preferably applied in the form of a suspension comprising between 1×10⁶ to 1×10⁹ total conidia per milliliter.

The method of the invention, which comprises applying the biocontrol composition comprising a mixture of Trichoderma harzianum and Clonostachys rosea, additionally elicits defense mechanisms in grapevine plants.

### EXAMPLES

### Example 1

### Obtaining a Composition of the Invention

1.1 Introduction. The process begins with the cultivation of each fungal biocontroller (Trichoderma harzianum and Clonostachys rosea) in independent Petri plates, which contain the potato-dextrose-agar (PDA) medium. These plates are called Initial Petri Plates (PPI1 corresponding to Trichoderma harzianum and PPI2 corresponding to Clonostachys rosea), and from these, the initial inocula are obtained for the massive multiplication of each microorganism in Petri plates with the aforementioned culture medium (PDA).

1.2 Initial inocula multiplication. For doing this, the number of samples necessary to inoculate the number of Petri plates established beforehand, from PPI1 and PPI2 is taken. Petri plates are covered and incubated in an oven at 28° C. until each biocontroller completely covers the surface of the plate. The plates are removed from the stove, the top cover is removed, and the surface is raked to obtain the microorganism.

1.3 Obtaining conidia. The material raked from the Petri plates from PPI1 or from PPI2 is placed in a 10% NaCl solution contained in separate flasks that also contain glass beads (30 mL NaCl solution+20 glass beads approx., for each raked Petri plate), and shaken manually to separate the conidia from the mycelium of the microorganism. Then, it is filtered through a funnel to which a sandwich consisting of two layers of sterile gauze and sterile hydrophilic cotton has been placed, which retains the mycelium and allows the suspension of conidia to be obtained. The conidia concentration is measured through a hemacytometer. In case that it is required to increase the concentration of conidia, the suspension can be centrifuged, the supernatant removed, and the residue suspended in a volume of less than 10% NaCl.

1.4 Obtaining the formulation. Suspensions formed by the conidia from each fungal strain are adjusted to the same concentration and are mixed in the desired volume ratio, from 5:1 to 1:5 (Trichoderma harzianum: Clonostachys rosea). Thus, there is the biocontrol mixture of the invention.

### Example 2

### Growth Inhibition of Plaque Phytopathogenic Fungi: Direct Antagonism

The biocontroller effect (growth inhibitor) on the phytopathogenic fungi N. australe and D. seriata is analyzed by cultivating them in Petri plates in the presence of a composition of the invention, obtained according to example 1, with a ratio from 5:1 at 1:5 between conidia of Trichoderma harzianum and Clonostachys rosea.

2.1. Introduction. The process begins with the cultivation of each fungal biocontroller (Trichoderma harzianum and Clonostachys rosea) in independent Petri plates, which contain the potato-dextrose-agar (PDA) medium. These plates are called Initial Petri Plates (PPI1 corresponding to Trichoderma harzianum and PPI2 corresponding to Clonostachys rosea), and from these, the initial inocula are obtained for the massive multiplication of each microorganism in Petri plates with the aforementioned culture medium (PDA).

2.2. Assay of inhibition of pathogen development. The developmental inhibitory effect is analyzed by inoculating Petri plates containing PDA with a disc from a pure culture of the pathogen, which is located 2 cm from the edge of the plate. At the direct end, a well is generated in the agar, in which a volume of the corresponding mixture is placed. The plates are incubated at 25° C. for 7 days. At the end of this time, the pathogen development radius, expressed in mm, is measured. This value is compared with the development radius of the pathogen in a control, which is carried out in the same way but where the mixture is replaced by 10% NaCl. Results are expressed as % inhibition.

The results (Table 1) quantified as a percentage of inhibition of the development of the pathogens N. australe and D. seriata, show by way of example the effect of direct antagonism of the mixture 1:1 of biocontrollers of the invention.

TABLE 1
ANTAGONISM OF FUNGAL STRAINS IN MIXTURE 1:1

| Antagonist | Pathogen | Mycelial growth inhibition (%) | |
|---|---|---|---|
| Trichoderma harzianum | N. australe | 35.4 | A |
| Clonostachys rosea | N. australe | 29.4 | B |
| Mixture 1:1 | N. australe | 34.8 | A |
| Trichoderma harzianum | D. seriata | 54.9 | C |
| Clonostachys rosea | D. seriata | 42.0 | B |
| Mixture 1:1 | D. seriata | 74.1 | A |

*Averages with a common letter are not significantly different (Fisher's LSD, p > 0.05).

The results in Table 1 show that in direct inhibition tests, the mixture of the invention maintains the effects of Trichoderma harzianum on the growth of N. australe, while surprisingly it shows a significantly higher efficacy on the growth of D. seriata.

On the other hand, mixtures of the two components of the invention were evaluated in different proportions, to determine if the proportion between both two affects the biocontrolling properties of the invention. The studied different mixtures and their results are shown in Table 2.

TABLE 2
ANTAGONISM OF FUNGAL STRAINS
IN DIFFERENT MIXTURES

| | | |
|---|---|---|
| Antagonist | Pathogen | Mycelial growth inhibition (%) |

| | | | |
|---|---|---|---|
| Mixture 1:1 | N. australe | 34.8 | A |
| Mixture 2:1 | N. australe | 34.71 | A |
| Mixture 1:2 | N. australe | 34.27 | A |
| Mixture 1:1 | D. seriata | 74.1 | A |
| Mixture 2:1 | D. seriata | 73.08 | A |
| Mixture 1:2 | D. seriata | 71.75 | A |

*Averages with a common letter are not significantly different (Fisher's LSD, p > 0.05).

The results show that there are no significant differences between the different mixtures, with different proportions of Trichoderma harzianum and Clonostachys rosea and their inhibitory effect on the studied pathogens. Without wishing to be bound by theory, we propose that this is due to the specific behavior and outdated development of each biocontroller. Preliminary experiments with mixtures in other proportions showed similar results to those included in Table 2.

### Example 3

### Size of the Lesion Produced by N. australe and D. seriata in Grapevine Cuttings

The biocontroller effect (inhibitor of development) of N. australe and D. seriata quantified as the size of the lesion produced by pathogens in grapevine cuttings is analyzed, in the presence and absence of mixtures.

3.1. Introduction. The process begins with the cultivation of each fungal biocontroller (Trichoderma harzianum and Clonostachys rosea) in independent Petri plates, which contain the potato-dextrose-agar (PDA) medium. These plates are called Initial Petri Plates (PPI1 corresponding to Trichoderma harzianum and PPI2 corresponding to Clonostachys rosea), and from these, the initial inocula are obtained for the massive multiplication of each microorganism in Petri plates with the aforementioned culture medium (PDA).

3.2. Preparation of grapevine cuttings. The grapevine cuttings (two nodes) are prepared from vine shoots harvested in the Metropolitan Region, Chile, in the pruning season (July) from healthy crop plants Cabernet Sauvignon and Chardonnay. The shoots were selected according to their thickness and health. The cuttings were subsequently stored at 4° C. in polyethylene bags until use.

3.3. Assay. The unrooted cuttings of the mentioned crops were disinfected externally by immersing them in a 10% ethanol solution for five minutes and allowed to dry in a clean environment. Subsequently, a cut was made in the upper part imitating a pruning cut. Controls were treated with sterile distilled water and treatments were inoculated simultaneously with the corresponding pathogen (1×10⁴ conidia/ml) and the corresponding biocontroller mixture. For doing this, the suspension of the pathogen was mixed with the corresponding mixture. The antagonist mixtures contained Carboxymethylcellulose as a thickener and tackifier, at a final concentration of 0.5%. The application on the pruning cuts was made with a sterile brush, and then the cut was covered with Parafilm.

The evaluations were: a) Length of the lesion produced by the infection of the pathogen in mm, and b) spread of the pathogens in an asymptomatic area. For the latter, wedge-shaped samples were taken with a sterile scalpel from the area located 0.5 cm below the lesion generated in each treatment. The samples were plated with PDA medium and kept at 22° C. for 5 days. A macroscopic identification of the recovered microorganisms was carried out comparing with strains identified as N. australe and D. seriata. For identifying, the color and type of mycelium were compared, development speed in PDA.

Additionally, samples were taken from the observed lesion to verify the presence of the pathogen in the necrotic area, the samples were seeded in plates with PDA medium and kept at 22° C. for 5 days. A macroscopic identification of the recovered microorganisms was carried out, comparing them with strains identified as N. australe and D. seriata, for identifying, the color and type of mycelium were compared, development speed in PDA.

The results show, by way of example, the effect of the mixture 1:1 on the length of the lesion produced by D. seriata and by N. australe in unrooted grapevine cuttings (Table 3) and on the presence of these pathogens in asymptomatic tissue from grapevine cuttings (Table 4).

TABLE 3
Effect of the mixture 1:1 on the length of the lesion produced by
D. seriata and N. australe in unrooted grapevine cuttings.

| Product | Pathogen | Lesion length (mm) | |
|---|---|---|---|
| No | D. seriata | 2.08 | A |
| No | N. australe | 1.18 | B |
| Mixture 1:1 | D. seriata | 1.17 | B |
| Mixture 1:1 | N. australe | 0.82 | B |

*Averages with a common letter are not significantly different (DGC, p > 0.05).

The results in Table 3 show that the composition of the invention (mixture 1:1) allows controlling the infection of both pathogens, obtaining smaller lesions under these conditions.

TABLE 4
Effect of the mixture 1:1 on the presence of the
pathogens D. seriata and N. australe in asymptomatic
tissue of unrooted grapevine cuttings.

| Product | Pathogen | Pathogen presence (%) | |
|---|---|---|---|
| No | D. seriata | 100 | A |
| No | N. australe | 100 | A |
| Mixture 1:1 | D. seriata | 0 | B |
| Mixture 1:1 | N. australe | 0 | B |

*Averages with a common letter are not significantly different (DGC, p > 0.05).

The result shows that the composition of the invention (mixture 1:1) allows to completely eliminate the phytopathogenic fungi D. seriata and N. australe in healthy tissue. This means that if the composition of the invention is applied preventively it would have a 100% effectiveness in the control of the dead arm disease of the grapevine.

### Example 4

### Size of the Lesion Produced by N. australe and D. seriata in Grapevine Cordons

The biocontroller effect (inhibitor of development) of N. australe and D. seriata quantified as the size of the lesion produced by pathogens in grapevine cordons is analyzed, (one-year-old shoot on two-year-old wood that corresponds to a productive shoot), inoculated with pathogens in the presence and absence of mixtures.

4.1. Introduction. The process begins with the cultivation of each fungal biocontroller (Trichoderma harzianum and Clonostachys rosea) in independent Petri plates, which contain the potato-dextrose-agar (PDA) medium. These plates are called Initial Petri Plates (PPI1 corresponding to Trichoderma harzianum and PPI2 corresponding to Clonostachys rosea), and from these, the initial inocula are obtained for the massive multiplication of each microorganism in Petri plates with the aforementioned culture medium (PDA).

4.2. Selection of grapevine plant cordons in the field. This assay contemplated the use of grapevine cordons in vineyards of cvs. Cabernet Sauvignon and Chardonnay. Plants with cordons of similar development stage (length and diameter) were located.

4.3. Assay. The treatments carried out were identical to those of the cuttings using, in this case, the previously selected cordons of a similar state of development. These were cut at the top, imitating a pruning cut, leaving three nodes at the base. A Data Logger was kept in the field to record humidity and temperature, during the assay development time under field conditions. Additionally, the produced rainfall record during the development of the assay was obtained from the records of the Red Agrometeorológica de INIA.

The assay was carried out from July and the evaluation was carried out in April. Each treatment was applied in three pruning cuts per plant. The experimental unit was four plants, with 5 repetitions, under a completely randomized experimental design.

The evaluations were: a) Length of the lesion produced by the infection of the pathogen in mm, and b) spread of the pathogens in an asymptomatic area. For the latter, wedge-shaped samples were taken with a sterile scalpel from the area located 0.5 cm below the lesion generated in each treatment. The samples were plated with PDA medium and kept at 22° C. for 5 days. A macroscopic identification of the recovered microorganisms was carried out, comparing them with strains identified as N. australe and D. seriata, for identifying, the color and type of mycelium were compared, development speed in PDA.

Additionally, samples were taken from the observed lesion to verify the presence of the pathogen in the necrotic area, the samples were seeded in plates with PDA medium and kept at 22° C. for 5 days. A macroscopic identification of the recovered microorganisms was carried out, comparing them with strains identified as N. australe and D. seriata, for identifying, the color and type of mycelium were compared, development speed in PDA.

The results, after statistical analysis, were expressed as the length of the lesion in mm (Table 5), and the percentage of pathogens spread in asymptomatic tissue from the recovery data of N. australe and D. seriata from the area indicated in each crop. (Table 6), compared to inoculated controls. In the case of N. australe (Table 5), the lesion is similar to the control due to greater aggressiveness of the pathogen. However, the mixture prevents the spread of this pathogen as observed in Table 6.

TABLE 5
Effect of the mixture 1:1 on the length of the lesion produced by
D. seriata and N. australe in cordons of grapevine plants.

| Product | Pathogen | Lesion length (mm) | |
|---|---|---|---|
| No | D. seriata | 3.89 | A |
| No | N. australe | 3.77 | A |
| Mixture 1:1 | D. seriata | 0.42 | B |
| Mixture 1:1 | N. australe | 3.82 | A |

*Averages with a common letter are not significantly different (DGC, p > 0.05).

In this application, it is observed that the composition of the invention very significantly reduces the size of the lesion mediated by D. seriata.

TABLE 6
Effect of the mixture 1:1 on the presence of pathogens D. seriata
and N. australe in cordons of grapevine plants.

| Product | Pathogen | Pathogen presence (%) | |
|---|---|---|---|
| No | D. seriata | 78 | A |
| No | N. australe | 44 | B |
| Mixture 1:1 | D. seriata | 0 | C |
| Mixture 1:1 | N. australe | 0 | C |

*Averages with a common letter are not significantly different (DGC, p > 0.05).

These results show that the composition of the invention completely REMOVES the pathogens N. australe and D. seriata.

### Example 5

### Defense Induction in Grapevine Plants of the cvs. Cabernet Sauvignon and Chardonnay

The induction of the enzymes Phenylalanine ammonium lyase (PAL), chitinases and endoglucanases, which are related to defense mechanisms against pathogens in grapevine seedlings inoculated with the mixture of biocontrollers, is analyzed.

5.1. Introduction. The process begins with obtaining grapevine seedlings with two true leaves of the mentioned crops, from seeds grown in trays containing sterile substrate (peat:soil:perlite=1:1:1), and with irrigation using sterile drinking water, in the greenhouse and at 25° C.

5.2. Seedling inoculation. Seedlings undergo mechanical damage and are inoculated in the area of damage with the mixture of biocontrollers (1×10⁸ total conidia, of both components of the mixture). Inoculated seedlings are kept at 25° C. until processing. Seedlings with mechanical damage without inoculation are used as a control.

5.3. Analysis. At different times since inoculation, seedlings are processed to quantify total proteins and the activities of PAL, chitinases, and endoglucanases. The results correspond to the value of the enzymatic activities of the inoculated seedlings, discounting the value of the same enzymatic activities in the control seedlings, and the basal activity. Activities are expressed as some multiple of kat mgprot⁻¹.

The results show a single induction of PAL at 12 hours post-inoculation (Table 7a), and multiple induction of Endochitinases (ECH, Table 7b) and Endoglucanases (EGL, Table 7c) in later times, in accordance with the mechanisms of defense induction in plants.

TABLE 7
Enzymatic activities of Phenylalanine ammonium lyase
(PAL), Endochitinases (ECH) and Endoglucanases (EGL)
in grapevine seedlings of the Cabernet Sauvignon and
Chardonnay crops, in the times of maximum induction.
a. PHENYLALANINE AMMONIUM LIASA (PAL)

| Time | Cabernet Sauvignon | Chardonnay |
|---|---|---|
| Max. activity | Enzymatic activity | Enzymatic activity |
| (hrs) | PAL (pkat/mg prot)* | PAL (pkat/mg prot)* |
| 12 | 0.85 | 9.35 |

b. ENDOCHITINASES (ECH)

| Time | Cabernet Sauvignon | Chardonnay |
|---|---|---|
| Max. activity | Enzymatic activity | Enzymatic activity |
| (hrs) | ECH (□kat/mg prot)* | ECH (mkat/mg prot)* |
| 24 | 70 | 920 |
| 60 | 270 | 930 |
| 84 | 20 | — |
| 96 | 130 | 1.110 |

c. ENDOGLUCANASES (EGL)

| Time | Cabernet Sauvignon | Chardonnay |
|---|---|---|
| Max. activity | Enzymatic activity | Enzymatic activity |
| (hrs) | EGL (mkat/mg prot)* | EGL (mkat/mg prot)* |
| 24 | 200 | 0.123 |
| 60 | 290 | 0.279 |
| 84 | 180 | 0.227 |

*The results correspond to the average of four replicates from three independent experiments, where the values of basal activity and mechanical damage were subtracted from those elicited. Standard deviation does not exceed 10%.

The results show that the analyzed enzymes are effectively being induced by the composition of the invention.

These examples are to be considered as illustrative and not limiting of the present invention, which is fully defined in the appended claims.

1. A biocontrol composition for phytopathogenic fungi, comprising: Trichoderma harzianum and Clonostachys rosea and an agronomically suitable vehicle.

2. The biocontrol composition according to claim 1, wherein Trichoderma harzianum and Clonostachys rosea are present in a ratio of between 1:5 to 5:1.

3. The biocontrol composition according to claim 1, wherein the mixture is formed by suspensions of conidia from Trichoderma harzianum y Clonostachys rosea.

4. The biocontrol composition according to claim 4, wherein the vehicle is selected from the group consisting of water, aqueous solutions, thick suspensions, granules and powders.

5. The biocontrol composition according to claim 1, wherein the biocontrol composition additionally comprises selected additives from the group consisting of fertilizer, insecticide, fungicide, nematicide and mixtures thereof.

6. A method to prevent and control fungal diseases in plants, comprising applying the biocontrol composition comprising a mixture of Trichoderma harzianum and Clonostachys rosea, according to claim 1 in a plant prone to developing a fungal infection.

7. The method according to claim 6, wherein the plant disease is mediated by fungi of the Botryosphaeriaceae family.

8. The method according to claim 7, wherein the plant disease is mediated by fungi of the species Neofusicoccum australe and Diplodia seriata.

9. The method according to claim 6, wherein the plant is selected from the group consisting of flowers, ornamental plants, fruit vegetables, hydroponic crops, leafy vegetables and cabbage crops, pome fruits, deciduous trees, grapevines, citrus, pines, stone fruits, nuts, grains and herbs.

10. The method according to claim 9, wherein the plants to be treated are grapevines.

11. The method according to claim 6, wherein applying is carried out by spraying, liquid or dry application in furrows, soaking of plant material in pots, direct incorporation into the soil or planting mixtures in the greenhouse, granular formulations or granules, or direct treatment of seeds.

12. The method according to claim 6, wherein the biocontrol composition comprising a mixture of Trichoderma harzianum and Clonostachys rosea is applied in the form of a suspension comprising between 1×10⁶ to 1×10⁹ total conidia per milliliter.

13. The method according to claim 6, wherein applying the biocontrol composition comprising a mixture of Trichoderma harzianum and Clonostachys rosea elicits defense mechanisms in grapevine plants.
